(19) United States
(12) Patent Application Publication
(10) Pub. No.: US 2005/0156009 A1
(43) Pub. Date: Jul. 21, 2005

(54) Nail gun extension kit

(76) Inventor: James M. Gazlay, Tampa, FL (US)

Correspondence Address: LITMAN LAW OFFICES, LTD, PO BOX 15035, CRYSTAL CITY STATION, ARLINGTON, VA, 22215, US

(21) Appl. No.: 11/028,522

(22) Filed: Jan. 5, 2005

Related U.S. Application Data
(60) Provisional application No. 60/536,498, filed on Jan. 15, 2004.

(51) Int. Cl. B25C 1/04

(52) U.S. Cl. 227/130; 227/156

(57) ABSTRACT

The nail gun extension kit is an extension tool designed specifically for pneumatic nail guns used for roofing. A plate is set above the socket cap. Both the plate and socket cap are screwed in to the nail gun together. An L-shaped extension arm is pivotally mounted on the plate, allowing the user to adjust the angle of the nail gun relative to the handle for roofs of varying pitch. The top of the extension arm forms a handle, which houses a trigger. A vertical standard is attached to the handle and has a top end supporting a cuff that attached to the users arm, and a lower end attached to the rear end of the nail gun by an adjustable length link. A cable runs from the extension handle trigger to a trigger sling secured on the nail gun trigger, allowing remote firing of the nail gun.

### CROSS-REFERENCE TO RELATED APPLICATION

This application claims the benefit of U.S. Provisional Patent Application Ser. No. 60/536,498, filed Jan. 15, 2004.

### BACKGROUND OF THE INVENTION

1. Field of the Invention

The present invention relates to power tool extension sets, particularly to an extension kit for pneumatic nail guns of the type frequently used by roofers, so that the roofer can operate the nail gun while in a standing position.

2. Description of the Related Art

The power nail gun, particularly the pneumatic nail gun, is an invaluable tool of the modern day roofer. In the pneumatic nail gun, the amount of effort required to nail a shingle down has been reduced from repeated strikes with a hammer to the simple pull of a trigger. However, in the process of shingling a roof, nailing a shingle is a step that must be repeated hundreds of times. Even doing something as easy as pulling a trigger can become physically taxing when it must be done on bended knees, combined with repeated crawling of minute distances to set the next set of shingles in place. Roofers continue to suffer from back pain from bending over to nail roof shingles.

The physical burden lifted by the use of the nail gun can be lifted further still if there were a way to allow the shingle installer to do his work from a standing position, rather than from a kneeling position. To that end various nail gun extension inventions have been developed, as well as similar extensions designed for other hand or power tools that would ordinarily require the user to be in a kneeling position to operate. Known extension designs fail provide a mechanism to compensate for different pitches for ease of use on different pitched roofs. Known extensions provide only a single upright which is clamped to the conventional nail gun.

It would be desirable to provide a nail gun extension for a conventional nail gun having a mechanism to provide the capability of comfortable, upright operation on different roof pitches. It would also be desirable to provide a rugged nail gun extension which attaches directly by existing cap screw on the gun so as to provide the most steady connection possible with the nail gun. It would also be desirable to provide a forearm brace such the extension becomes an extension of the arm and dependence totally on the users hands is avoided, providing for longer use without tiring the hands of the user.

Thus, a nail gun extension kit solving the aforementioned problems is desired.

### SUMMARY OF THE INVENTION

The nail gun extension kit is an extension tool designed specifically for pneumatic nail guns of the type used in roofing. A plate is set above the socket cap. Both the plate and socket cap are screwed in to the nail gun together. An L-shaped extension arm is pivotally mounted on the plate, allowing the user to adjust the angle of the nail gun relative to the handle for roofs of varying pitch. The top of the extension arm forms a handle, which houses a trigger. A forearm brace near the back of the handle and an adjustable back brace attaching the back of the handle to the back of the nail gun give the user increased control for use with one hand, as well as the ability to adjust the handle for the pitch of the roof. A Bowden cable runs from the handle trigger to a trigger sling secured on the nail gun trigger, allowing remote firing of the nail gun.

Hence, the nail gun extension kit of the present invention relieves back strain by permitting the user to operate a pneumatic nail gun while in the standing position. The nail gun extension kit further provides for adjustment to accommodate different roof pitch angles, thereby rendering the extension kit more useful to the roofer.

In another embodiment, pitch adjustment is not supplied and the hand grip trigger similar to that of a bicycle brake grip is employed to control the Bowden cable, the design being rugged for sure handling of the nail gun.

### BRIEF DESCRIPTION OF THE DRAWINGS

FIG. 1 is an environmental, diagrammatic, side elevation view of a nail gun extension kit according to the present invention.

FIG. 2 is a top view of the extension arm bracket plate of a nail gun extension kit according to the present invention.

FIG. 3 is a perspective view of the triggering system of a nail gun extension kit according to the present invention.

FIG. 4 is a perspective view of the metal sock and cable of a nail gun extension kit according to the present invention.

FIG. 5 is a fragmented view of the triggering system with the cable detached.

FIG. 6 is a bottom view of the extension trigger with the cable attached.

FIG. 7 is a detail view of the cable mounting cylinder which acts as a connection to the nail gun trigger operating cable.

FIG. 8 is an elevation view of another embodiment of the nail gun extension kit of the present invention.

FIG. 9 is a detail view of the extension arm of FIG. 8.

FIG. 10 is an exploded detail view of the trigger grip housing and mounting block of FIG. 3.

FIG. 11 is a detail view of the cable and trigger actuating assembly of FIG. 8.

FIG. 12 is a detail view in perspective of the cable support and trigger actuating assembly of FIG. 8.

Similar reference characters denote corresponding features consistently throughout the attached drawings.

### DETAILED DESCRIPTION OF THE PREFERRED EMBODIMENTS

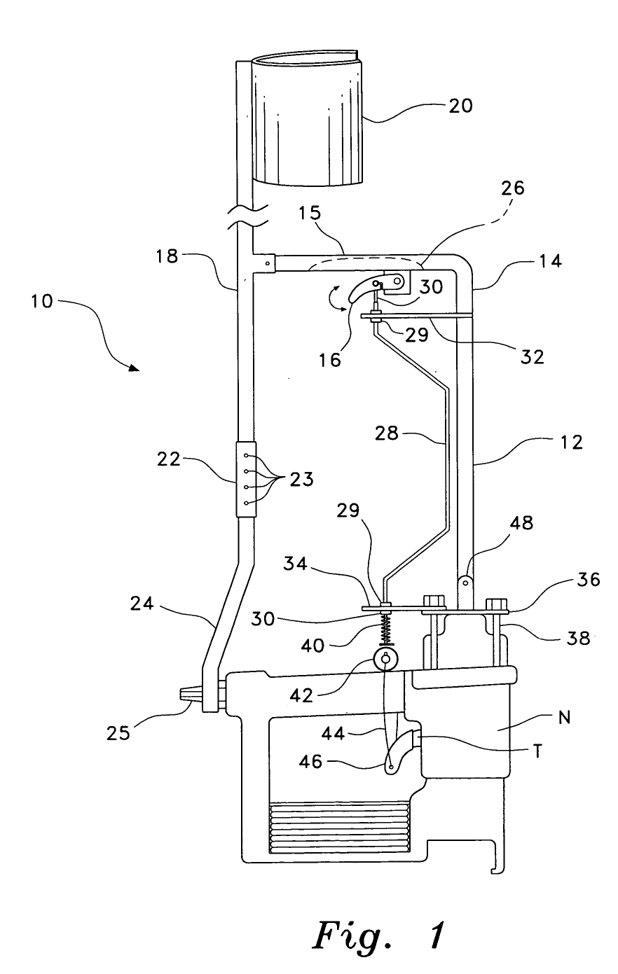

The present invention is a nail gun extension kit, designated generally as 10 in the drawings. The nail gun extension kit 10 is specifically designed to attach to a roofing nail gun N, as shown completely attached and ready for use in FIG. 1. The length of the extension, the secure connection to the nail gun N, and additional forearm bracing provided by the invention 10 allow the user to easily control and fire the nail gun N from a standing position.

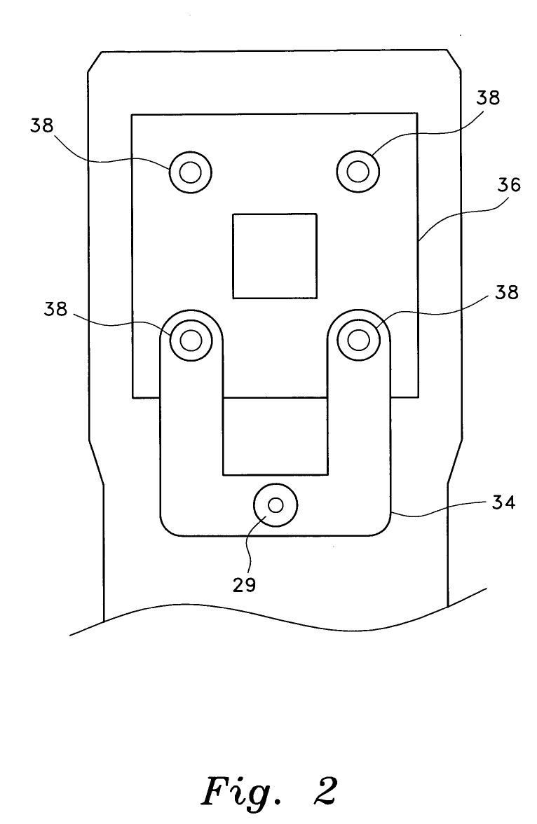

The conventional roofing nail gun has four screws securing a socket cap to the top of the nail gun. Referring first to FIG. 2, the nail gun extension kit 10 includes four shoulder screws 38 that are to be used to replace the original nail gun socket cap screws and secure the extension arm bracket plate 36 to the nail gun N. The extension arm bracket plate 36 has four holes, one in each corner, aligned with the standard configuration of the roofing nail gun socket cap screws. The shoulder screws 38 are long enough to pass through the four corner holes of the extension arm bracket 36 plate and into the four holes in the nail gun N, thereby simultaneously locking down the socket cap and firmly securing the extension arm bracket plate 36 to the top of the nail gun N.

As shown in FIG. 1, An L-shaped extension arm member 12 is pivotally connected to the clevis extending upward from the extension arm bracket plate 36 allowing rotation relative thereto. The extension arm member 12 is of sufficient length to allow the average user to handle the nail gun comfortably from a standing position. The extension arm member 12 includes a first arm 14 extending substantially vertical from the front of the nail gun N and a second arm orthogonal to first arm 14 which extends substantially horizontal, parallel to and above the top of nail gun N, and defining an extension arm handle 15. The lower end portion of first arm 14 is pivotally attached to extension arm bracket 36, e.g., by a clevis 48 extending from extension arm bracket 36 and a bolt, clevis pin, hitch pin, cotter pin, or other pivot pin extending through clevis 48 and first arm 14. The pivotal attachment of L-shaped extension arm member 12 to extension arm bracket 36 permits the angle of the nail gun N to be adjusted for the pitch of the roof, as described below.

Continuing to refer to FIG. 1, the rear end of the extension handle section 15 is attached to a vertical standard 18. The standard 18 is perpendicular to the handle section 15 and has an upper end portion extending above extension handle section 15 and a bottom end potion extending below extension handle section 15. A padded forearm strap or cuff 20 is attached to the upper end portion of standard 18. Such padded straps are conventional in construction and will not be described in detail here. The padded forearm strap 20 may be secured to the user's forearm by customary fasters such as male and female snaps or hook and loop fasteners.

The bottom portion of the standard 18 is attached to an adjustable link joint 22. The adjustable link joint 22 contains several vertically aligned detent holes 23. A trailing link 24 is telescopically inserted into the adjustable link joint 22. The trailing link 24 has a spring-loaded detent button that can snap into any of the detent holes of the adjustable link joint 22 in a well-known manner. The setting of the trailing link determines the angle at which the nail gun N will rest relative to the handle section 15 held by the user. Lowering the setting of the trailing link 24 by snapping the button into lower holes will increase the angle; raising the trailing link 24 will decrease the angle. Thus, the adjustable link joint 22 works in cooperation with the pivotally attached lower end portion of first arm 14 to adjust the angle setting of the nail gun N to the pitch angle of the roof. This feature gives the user the ability to make adjustments for the pitch of the particular roof that is currently being shingled.

The bottom of the trailing link may be constructed of material which allows resilient bending to allow for angle setting and pivotally attaches to an air inlet port 25. The air inlet port 25 is designed to screw on to the air inlet of the nail gun N and functions as a conduit between the air hose and nail gun N.

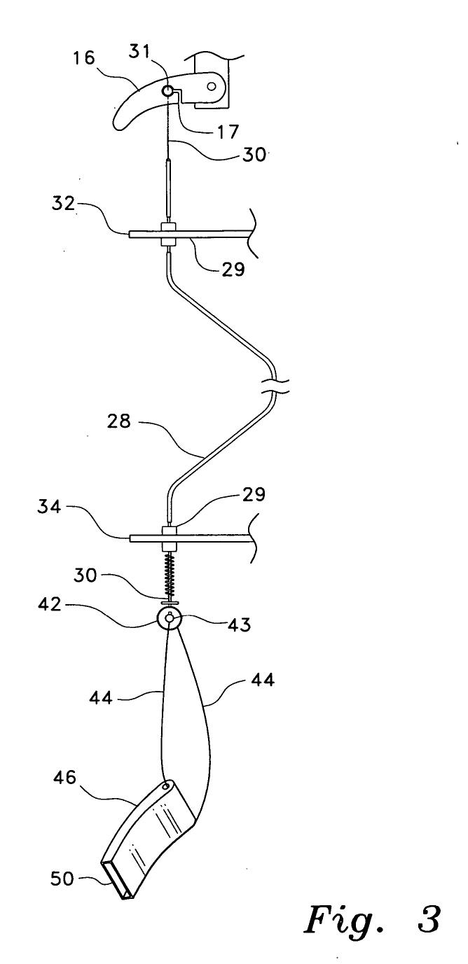

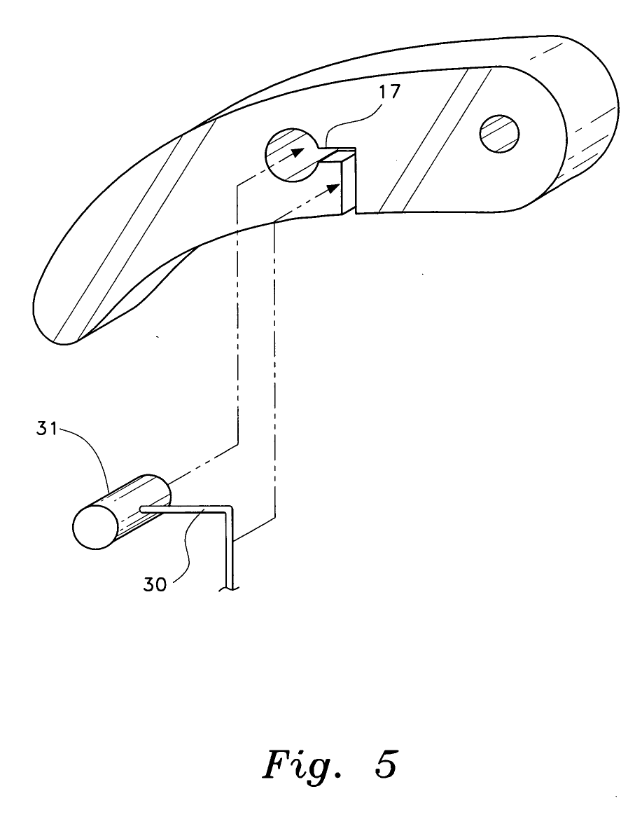

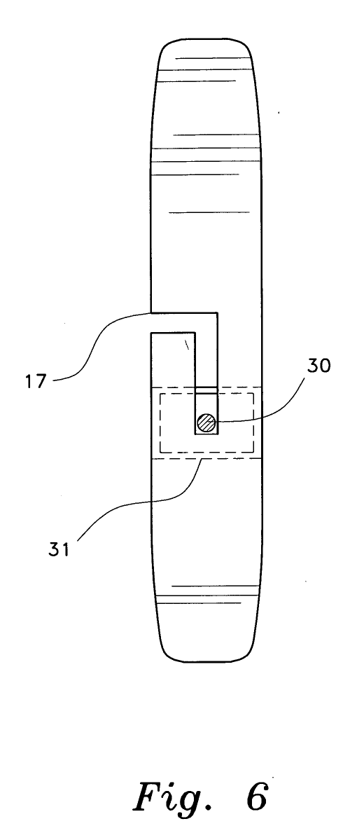

Returning to the extension handle section 15 of the extension arm member 12, a trigger 16 is located below the handle section 14. FIG. 3 shows the trigger system that allows the user to pull extension trigger 16 from a standing position, which correspondingly pulls the nail gun trigger T, thereby firing a nail. The trigger 16 is attached to a cable 30. The attachment between the extension trigger 16 and the cable 30 can be accomplished in any conventional manner. The preferred embodiment, as shown in FIG. 5, uses an L-shaped slot 17 cut in the trigger 16. The cable 30 is attached to a barrel 31, which is inserted into circular portion of the slot 17 simultaneously with the cable 30 being inserted at a right angle through the L-shaped slot. FIG. 6 shows a bottom view of the trigger 16. After being inserted into the, L-shaped slot 17, the cable 30 may then slip downwards thereby securing the cable 30 to the extension trigger 16, insuring there will be no lateral movement of the barrel 31.

The cable 30 is a sheathed or jacketed cable of the Bowden type, so that cable sheath 28 protects the cable 30. The cable sheath 28 is tubular and may be constructed of a flexible, rigid material, such as plastic or wound wire. As shown in FIGS. 1 and 3, the cable sheath 28 runs the length between an upper support bracket 32, located near the top of the extension arm member 12 and securely affixed to vertical first arm 14 and a lower support bracket 34 located just below the extension arm 12 and securely affixed atop the extension arm bracket plate 36, respectively. The upper support bracket 32 is secured to the first arm 14 shortly below the junction with extension handle section 15 by any conventional means, such as screws, glue, or welding, depending upon the selected composition of the extension arm member 12. The lower support bracket 34 is secured to the extension arm bracket plate 36 by the two rear shoulder screws 38, as can be seen more clearly in FIG. 2.

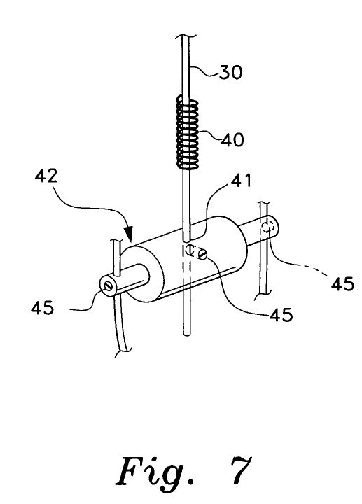

Referring back to FIG. 3, the cable 30 runs through sheath connector 29 located in upper support bracket 32, the cable sheath 28, through another sheath connector 29 located in lower support bracket 34, a compression spring 40, through a washer as desired, and ultimately terminates by attachment to trigger cable mounting cylinder 42. The trigger cable mounting cylinder 42 is cylindrical in shape (see FIG. 7), having outer end portions 43. A centrally located vertical cable receiving bore 41 receives cable 30 and is held in place by a radially directed set screw 45. Trigger cable 44 threads through trigger sock 46 having trigger receiving opening 50. The remote ends of trigger cable 44 extend upward through respective outer end portions 43 and are held by axially located setscrews 45. The effective length of cable 30 and trigger cable 44 may be adjusted by loosening and resetting setscrews 45.

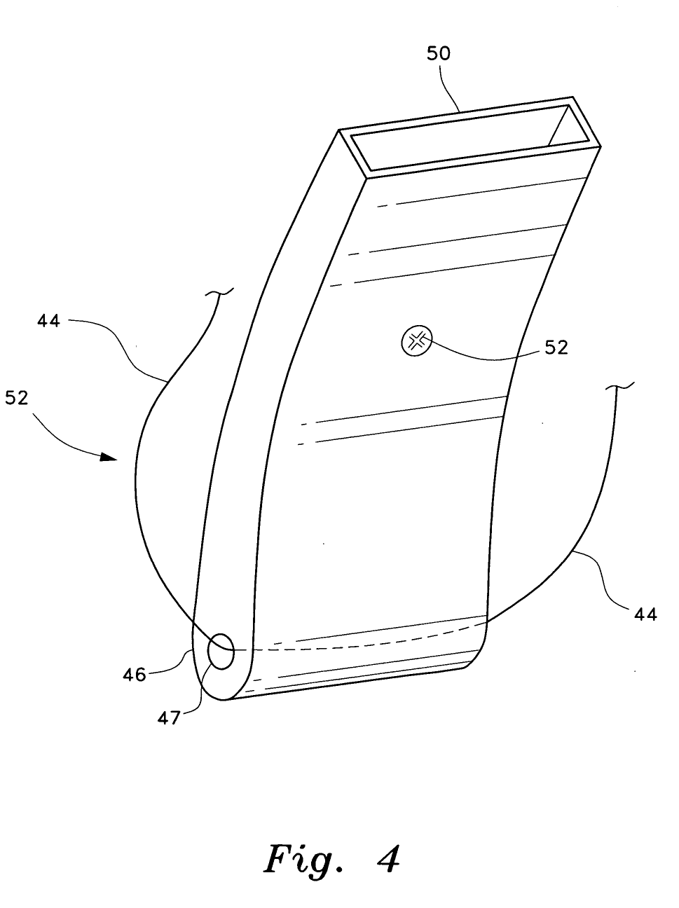

FIG. 4 shows the trigger sling 52 in greater detail detached from the trigger cable mounting cylinder 42. The trigger cables 44 extend out of either end of an end bore 47 in trigger stock 46 and secure the trigger sling 52 upon the trigger T of the nail gun N. The trigger sling 52 is further secured by tightening a setting screw 54.

Referring back to FIG. 3, in operation, when the user pulls the extension trigger 16 to which the upper end portion of cable 30 is attached, the cable 30 transfers the upward force to the lower end portion of cable 30 attached to cable mounting cylinder 42 and correspondingly the trigger sling 52, thereby pulling the nail gun trigger T and firing the nail gun N. Simultaneously, the upward movement of the cable mounting cylinder 42 compresses the spring 40 between the lower cable support bracket 34 and the mounting cylinder 42 or washer, as desired. Upon the user's release of the extension trigger 16, the spring 40 will force the cable mounting cylinder 42 back downward to its original position, thereby overcoming any inner friction between the cable 30 and the cable sheath 28 and lowering the trigger sling 52, releasing the nail gun trigger T back to its original position.

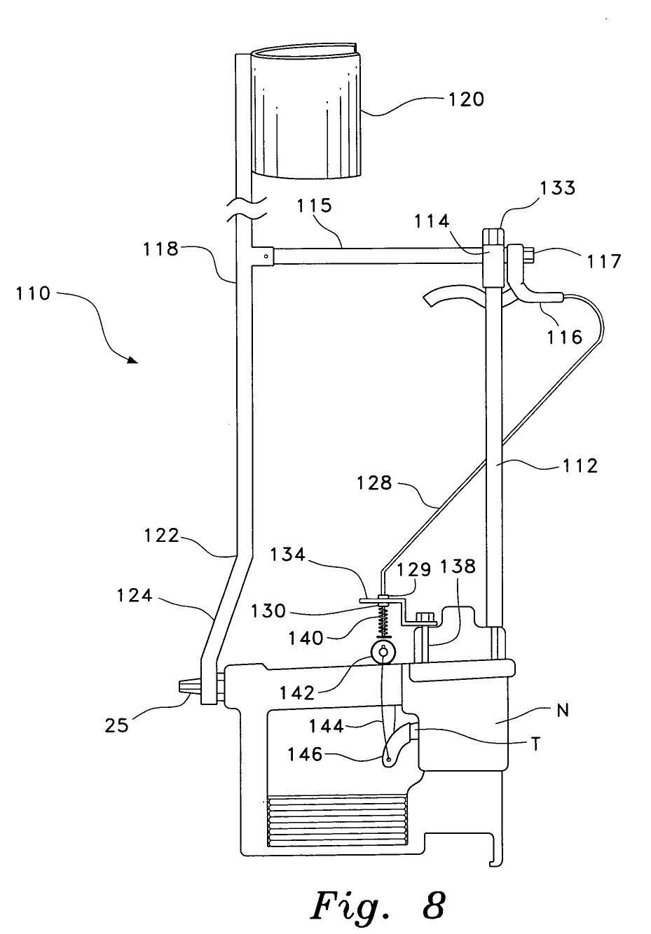

Referring to FIG. 8, there is shown an environmental, diagrammatic, side elevation view of another embodiment of the nail gun extension kit, designated by the reference number 110. Nail gun extension kit 110 includes an extension arm member made up of two laterally spaced extension first arms 112 mounted to a mounting block 114 and secured by mounting block cap screws 133 and a handle extension section 115 extending between vertical standard 118 and mounting block 114. Trigger assembly 116 is attached at the forward end of handle extension section 115 and mounting block 114 by trigger assembly mounting bolt 117.

A forearm cuff 120 is attached to vertical standard 118 at the upper portion thereof and is similar to that of cuff 20 of the embodiment of FIG. 1. Vertical standard 118 is attached at its lower end portion to trailing link 124 connected at its upper end portion to vertical standard 118 and is attached to nail gun N at the pressure air inlet connection 25. The vertical standard 118 and trailing link 124 may be a single piece of tubing or the like bent to form bend 122.

Cable shield 128 and cable 130 extend downward from trigger assembly 116 and are of the Bowden type widely used for controlling brakes on bicycles. Shield 128 is held in place at its lower end by sheath connector 129 to lower support bracket 134. Cable 130 is attached at its lower end to mounting cylinder 142 which is separated from lower support bracket 134 by compression spring 140. Lower support bracket 134 is offset downward to match the rearward shoulder of the socket cap of nail gun N and is attached by shoulder screws 138. Extension arms 112 are attached at their respective lower ends to the forward shoulder of the socket cap. Trigger cable 144 extends downward from mounting cylinder 142 and threads through the lower end of trigger sling 146 which is mounted over trigger T of nail gun N.

The embodiment of FIG. 8 operates similarly to that of FIG. 1 as described above wherein handle extension section 115 and the trigger of trigger assembly 116 are grasped by a users hand. Upon squeezing the trigger assembly 116 the cable 130 pulls upward on mounting cylinder 142 against compression spring 140 and thereby pulls trigger sling 146 by means of trigger cable 144, pulling trigger T and activating the nail gun N. Upon release of trigger assembly 116, spring 140 pushes downward on mounting cylinder 142, extending cable 130 to its original position and releasing tension on trigger T.

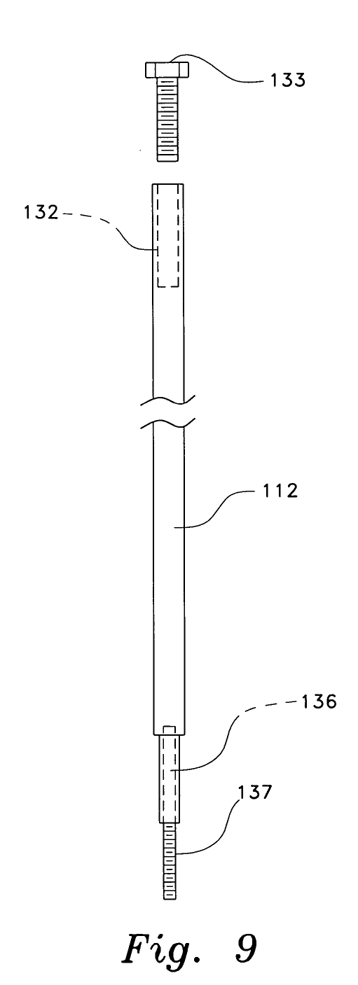

Referring to FIG. 9, there is shown a detail view of an extension arm first arm 112 having a cap screw receiver 132 at its upper end for receiving mounting block cap screw 133. Extension arm first arm 112 has a stud receiver 136 for receiving a mounting stud 137.

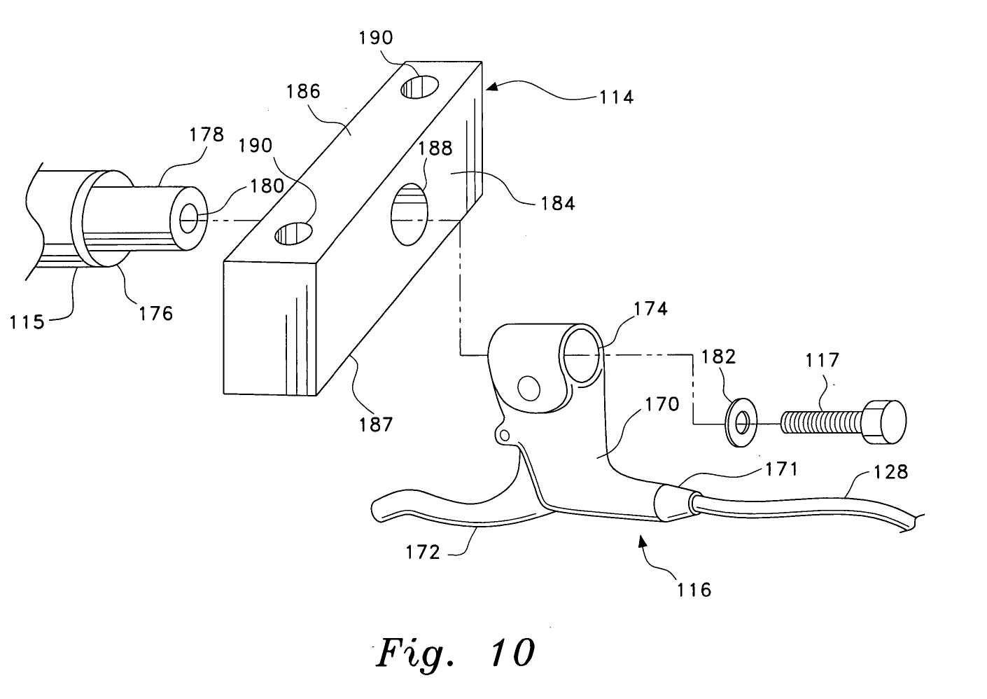

Referring to FIG. 10 there is shown an exploded detail view of the mounting block system for mounting trigger assembly 116. Handle extension section 115 has a shoulder 176 forming handle extension trigger housing mount 178. Trigger assembly 116 includes trigger housing 170, trigger 172, and mounting bolt receiver 174 at its upper portion. Cable sheath 128 is connected to housing 170 at crimp 171. Mounting block 114 is generally rectangular, extending crosswise relative to the extension kit 110 and has an upper wall 186, a lower wall 187 and opposed front and rear walls 184. Mounting block 114 has vertical cap screw receivers 190 at each end for receiving mounting block cap screws 133 for mounting on respective vertical extension arm first arms 112. A centrally located trigger housing mount receiving bore 188 extends through front and rear walls 184 of block 114 so as to receive trigger housing mount 178 of handle extension 115. Upon assembly, trigger housing mounting bolt receiver 174 extends over the portion trigger housing mount 178 extending outward from mounting block 114 and is secured in place by trigger housing mounting bolt 117 and washer 182 as screwed into trigger mounting bolt receiver 180 axially located in trigger housing mount 178.

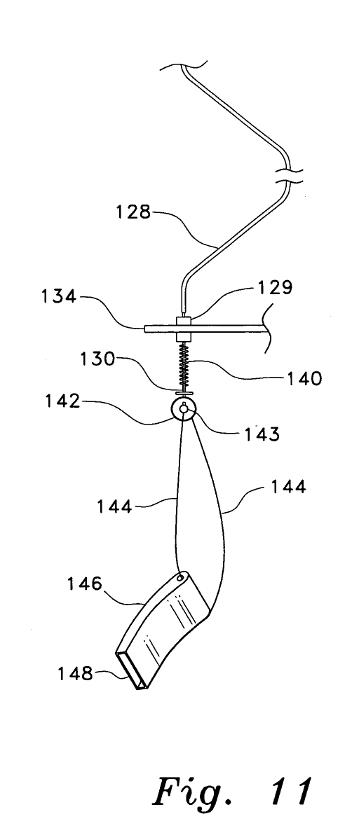

Referring to FIG. 11, there is shown a detail view of the cable and trigger sling assembly wherein cable 130 extends through shield 128 held by sheath connectors 129.to lower support bracket 134. The end portion of cable 130 is held by mounting cylinder 142 with compression spring 140 located over cable 130 between lower support bracket 134 and mounting cylinder 142. Trigger cable 144 is threaded through trigger sling 146 and secured at each end at mounting cylinder end portions 143. Trigger sling 146 has a trigger receiving end for receiving the trigger T of nail gun N.

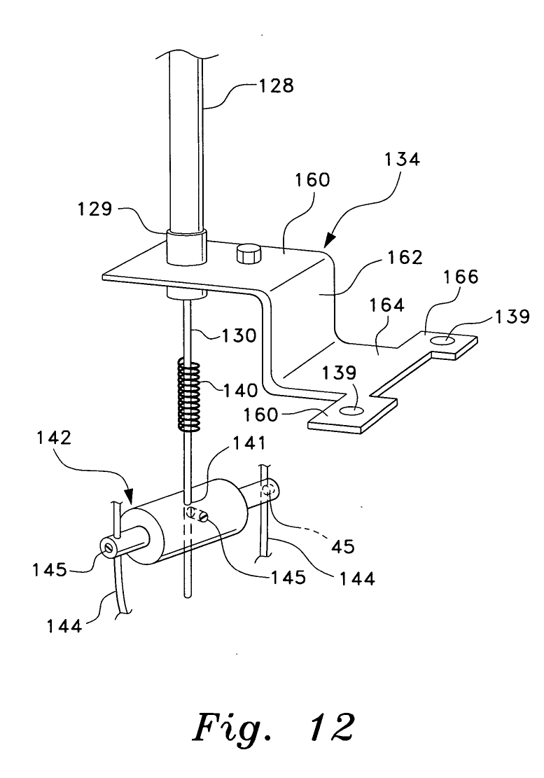

Referring to FIG. 12, there is shown a detail perspective view of the lower support bracket, cable and mounting cylinder assembly. Cable 130 extends downward through sheath 128 and through the upper horizontal portion 160 of offset lower mounting plate 134 at sheath connector 129. Lower support bracket 134 has a lower horizontal portion 164 attached to upper horizontal portion 160 by vertical portion 162. The lower portion 164 extends forward, forming a generally “C”-shaped portion having a shoulder screw bore 139 at each side configured to be mounted on the rear portion of the socket cap of nail gun N by shoulder screws 138.

It is to be understood that the present invention is not limited to the embodiments described above, but encompasses any and all embodiments within the scope of the following claims.

1. A nail gun extension kit for a pneumatic nail gun, comprising:
an extension arm member having at least one elongate vertical first arm for attachment to a front end of the nail gun and a second arm extending normal to said first arm and forming an extension handle section;
a vertical standard spaced rearwardly of and extending substantially parallel to said first arm and attached to said extension handle section, said standard having a vertical upper portion having an upper end portion and a lower end portion extending downward joining a trailing link, said trailing link having an upper end portion attached to said lower end portion of said standard and a lower end portion for attachment to a rear end of the nail gun;
an extension trigger pivotally attached to said extension handle section; and
a cable linkage having a first end attached to said extension trigger and a second end for attachment to a trigger of the nail gun;
whereby, upon pulling the extension trigger the cable linkage activates the trigger of the nail gun.

2. The nail gun extension kit of claim 1, further comprising a forearm cuff attached to said vertical standard at said upper end portion at a point above said attachment to said extension handle section for vertically receiving the forearm of a user.

3. The nail gun extension kit of claim 1, wherein said extension arm is an integral L-shaped extension arm having an elongate vertical first arm for pivotal attachment to a front end of the nail gun.

4. The nail gun extension kit of claim 3, said cable linkage comprising a cable and a generally vertical sheath having an upper end and a lower end, said cable having an upper portion extending above said sheath for mounting to said extension trigger and a lower portion extending below said sheath for activation of the trigger of the nail gun, said cable being movable within said sheath for activation of the trigger of the nail gun, said sheath being fixed relative to said first arm.

5. The nail gun extension kit of claim 4, said cable linkage further comprising an upper support bracket supported by said L-shaped extension arm and a lower support bracket fixedly secured relative to the nail gun, said upper end of said sheath being fixedly attached to said upper support bracket and said lower end of said sheath being fixedly secured to said lower support bracket.

6. The nail gun extension kit of claim 5, further comprising an extension arm-bracket plate horizontally attached to the nail gun, and plurality of cap screws extending downward through said bracket plate and secured to the nail gun and acting to secure the nail gun socket cap to the nail gun, said lower support bracket being supported by at least one of said cap screws and extending rearward of said extension arm bracket plate.

7. The nail gun extension kit of claim 6, further comprising a clevis attached to and extending upward from said extension arm bracket plate, said first arm being rotatably attached to said clevis.

8. The nail gun extension kit of claim 7, further comprising a spring detent link joint adjustably connecting said lower end portion of said vertical standard to said trailing link.

9. The nail gun extension kit of claim 5, said cable linkage further comprising a mounting cylinder and a compression spring, said cable lower end being fastened to said mounting cylinder, said compression spring surrounding said cable between said lower support bracket and said mounting cylinder and bearing against said lower support bracket, whereby, upon pulling of said extension trigger, said mounting cylinder is pulled upward, placing said compression spring under compression against said lower support bracket and actuating the nail gun trigger, and whereby, upon release of said extension trigger, said compression spring forces said mounting cylinder downward, releasing the nail gun trigger.

10. The nail gun extension kit of claim 9, said mounting cylinder having opposed end portions extending therefrom, said cable linkage further comprising a trigger sling having a trigger sock having a trigger receiving end and an end bore, and a trigger cable having remote ends, said trigger sling extending over the nail gun trigger, said trigger cable extending through said end bore and the remote ends thereof being secured to said respective mounting cylinder end portions, whereby, upon the upward movement of said mounting cylinder, said trigger cable pulls upward on said trigger sling, pulling the nail gun trigger for actuation of the nail gun.

11. The nail gun extension kit of claim 10, said mounting cylinder defining a cable receiving bore for adjustably receiving said cable therethrough and a setscrew securing said cable within said mounting cylinder at a selected location, and said mounting cylinder end portions defining respective trigger cable bores for adjustably receiving said remote end portions of said trigger cable therethrough and respective setscrews securing said trigger cable within said trigger cable remote end portions at selected locations, whereby the effective length of said cable linkage is adjusted by adjusting and securing said cable and trigger within said mounting cylinder by said setscrews.

12. The nail gun extension kit of claim 2, said extension arm member further comprising a mounting block connecting said handle extension section and said at least one elongate vertical first extension arm.

13. The nail gun extension kit of claim 12, said extension arm comprising two laterally spaced elongate vertical first extension arms depending from said mounting block, said first extension arms having respective upper and lower portions, said upper portions being secured to said mounting block at laterally spaced locations thereto.

14. The nail gun extension kit of claim 13, said handle extension section having a trigger housing mount extending through said mounting block between said spaced locations of said upper portions of said first extension arms, said extension trigger further comprising a trigger housing mounted to said trigger housing mount at said mounting block.

15. The nail gun extension kit of claim 14, said cable linkage comprising a cable having an upper end portion and a lower end portion, and an elongated sheath having an upper end and a lower end, said cable upper end portion and said sheath upper end being operably connected with said trigger assembly, said cable lower portion extending below said sheath for activation of the trigger of the nail gun, said cable being movable within said sheath for activation of the trigger of the nail gun.

16. The nail gun extension kit of claim 15, said cable linkage further comprising a lower support bracket fixedly secured relative to the nail gun, said lower end of said sheath being fixedly secured to said lower support bracket, said lower bracket plate having at least one cap screw mounting said bracket plate to the rearward portion of the nail gun socket cap to the nail gun, said lower portions of said first extension arms having respective mounting studs extending therefrom and serving as cap screws to secure the forward portion of the socket cap to the nail gun.

17. The nail gun extension kit of claim 15, wherein said upper portions of said first extension arms define cap screw receivers and are attached to said mounting block by cap screws extending downward through vertical bores defined by said mounting block and into said cap screw receivers, and said trigger housing mount of said handle extension section defines a cap screw receiver and said extension trigger housing is attached to said mount by a cap screw so as to extend forward of said mounting block.

18. The nail gun extension kit of claim 17, said cable linkage further comprising a mounting cylinder and a compression spring, said cable lower end portion being fastened to said mounting cylinder, said compression spring surrounding said cable between said lower support bracket and said mounting cylinder and bearing against said lower support bracket, whereby, upon pulling of said extension trigger, said mounting cylinder is pulled upward, placing said compression spring under compression against said lower support bracket and actuating the nail gun trigger, and whereby, upon release of said extension trigger said compression spring forces said mounting cylinder downward, releasing the nail bun trigger.

19. The nail gun extension kit of claim 18, said mounting cylinder having opposed end portions extending therefrom, said cable linkage further comprising a trigger sling having a trigger sock having a trigger receiving end and an end bore, and a trigger cable having remote ends, said trigger sling extending over the nail gun trigger, said trigger cable extending through said end bore and the remote ends thereof being secured to said respective mounting cylinder end portions, whereby, upon the upward movement of said mounting cylinder, said trigger cable pulls upward on said trigger sling, pulling the nail gun trigger for actuation of the nail gun.

20. The nail gun extension kit of claim 19, said mounting cylinder defining a cable receiving bore for adjustably receiving said cable therethrough and a setscrew securing said cable within said mounting cylinder at a selected location, and said mounting cylinder end portions defining respective trigger cable bores for adjustably receiving said remote end portions of said trigger cable therethrough and respective setscrews securing said trigger cable within said trigger cable remote end portions at selected locations, whereby the effective length of said cable linkage is adjusted by adjusting and securing said cable and trigger within said mounting cylinder by said setscrews.
